(19) United States
(12) Patent Application Publication
(10) Pub. No.: US 2024/0149351 A1
(43) Pub. Date: May 9, 2024

(54) SYSTEMS AND METHODS FOR IMPROVED ADDITIVE MANUFACTURING

(71) Applicant: Nikon Corporation, Tokyo (JP)

(72) Inventor: Abdelmoula Haboub, Fremont, CA (US)

(73) Assignee: Nikon Corporation, Tokyo (JP)

(21) Appl. No.: 18/382,061

(22) Filed: Oct. 20, 2023

Related U.S. Application Data
(60) Provisional application No. 63/418,481, filed on Oct. 22, 2022.

(51) Int. Cl. B22F 10/80; B22F 10/25; B22F 10/28; B22F 12/37

(52) U.S. Cl. CPC B22F 10/80; B22F 10/25; B22F 10/28; B22F 12/37; B33Y 50/00

(57) ABSTRACT

The problem of slow 3D printing using a beam-guided search (BGS) method is addressed by systems and methods that apply variable volume threshold ratio (VTR) values to a BGS method, to generate a plurality of subvolume groups and a plurality of clipping plane groups corresponding to a model of a 3D printed part or component. The plurality of subvolume groups and the plurality of clipping plane groups are presented to an operator of a 3D printing system, who can select the subvolume group and clipping plane associated with an optimal VTR value (for instance, based on experience and intuition), thereby obtaining a high-quality part or component while speeding up the 3D printing procedure. The problem of transforming subvolume groups and clipping plane groups generated by decomposition procedures (such as BGS) into subvolume groups and clipping plane groups that can be printed by a 3D printing systems is addressed by systems and methods that apply a coordinate transformation into a coordinate system associated with the 3D printing system.

### CROSS-REFERENCE

The present application claims priority to U.S. Provisional Patent Application No. 63/418,481, entitled “SYSTEMS AND METHODS FOR IMPROVED ADDITIVE MANUFACTURING,” filed on Oct. 22, 2022, which application is incorporated herein by reference in its entirety for all purposes.

### BACKGROUND OF THE INVENTION

Additive manufacturing systems and methods, including three-dimensional (3D) printing systems and methods, have become prevalent over the past few years. In a 3D printing system or method, a part or component is constructed layer-by-layer, with each successive layer constructed on top of and bonded to the previous layer. Since the geometry of each layer can be individually controlled, such 3D printing systems and methods can be used to make complex parts or components that would be difficult or impossible to fabricate using conventional subtractive manufacturing methods (such as milling). However, the use of 3D printing systems and methods to make parts or components with overhanging regions has typically required the use of support structures to prevent the collapse of the overhanging regions due to gravity. Such support structures waste materials and/or may be difficult to remove from the 3D printed part or component. Multi-axis 3D printing systems and methods (such as four-axis, five-axis, or six-axis 3D printing systems and methods) may be coupled with beam-guided search (BGS) methods to produce 3D printed parts or components that have a significantly reduced need for support structures. Such multi-axis 3D printing systems and methods may include a processing head capable of moving in multiple linear directions (such as the x, y, and/or z directions) and a stage capable of rotating a part around multiple axes (such as pitch, yaw, and/or roll rotations). However, such methods may suffer from significant limitations. Accordingly, presented herein are systems and methods for improved additive manufacturing.

### BRIEF DESCRIPTION OF THE DRAWINGS

Various embodiments of the invention are disclosed in the following detailed description and the accompanying drawings.

FIG. 1 shows a flowchart depicting an exemplary method for generating subvolume groups and clipping plane groups representing a model of a part or component using a plurality of volume threshold ratios (VTRs) in a beam-guided search (BGS) procedure.

FIG. 2 shows an exemplary BGS procedure 200 associated with a single VTR value.

FIG. 3 shows a flowchart depicting an exemplary method for transforming a subvolume group and clipping plane group from a first coordinate system to a second coordinate system.

FIG. 4 shows a block diagram of a computer system for performing the method of FIGS. 1, 2, and/or 3.

FIG. 5 shows an exemplary slicing of an L-pipe using BGS and a plurality of VTRs.

FIG. 6 shows an exemplary slicing of a Y-pipe using BGS and a plurality of VTRs.

FIG. 7 shows an exemplary slicing of a four-way pipe using BGS and a plurality of VTRs.

FIG. 8 shows an exemplary slicing of a 120 degree bend pipe using BGS and a plurality of VTRs.

FIG. 9 shows an exemplary slicing of a 3-way pipe using BGS and a plurality of VTRs.

FIG. 10 shows an exemplary slicing of an octopus figure using BGS and a plurality of VTRs.

FIG. 11 shows exemplary transformations from the BGS coordinate system to the FDM coordinate system for the L-pipe of FIG. 5.

FIG. 12 shows exemplary transformations from the BGS coordinate system to the FDM coordinate system for the Y-pipe of FIG. 6.

FIG. 13 shows exemplary transformations from the BGS coordinate system to the FDM coordinate system for the octopus of FIG. 10.

FIG. 14 shows fabrication of an exemplary Y-pipe using the systems and methods described herein.

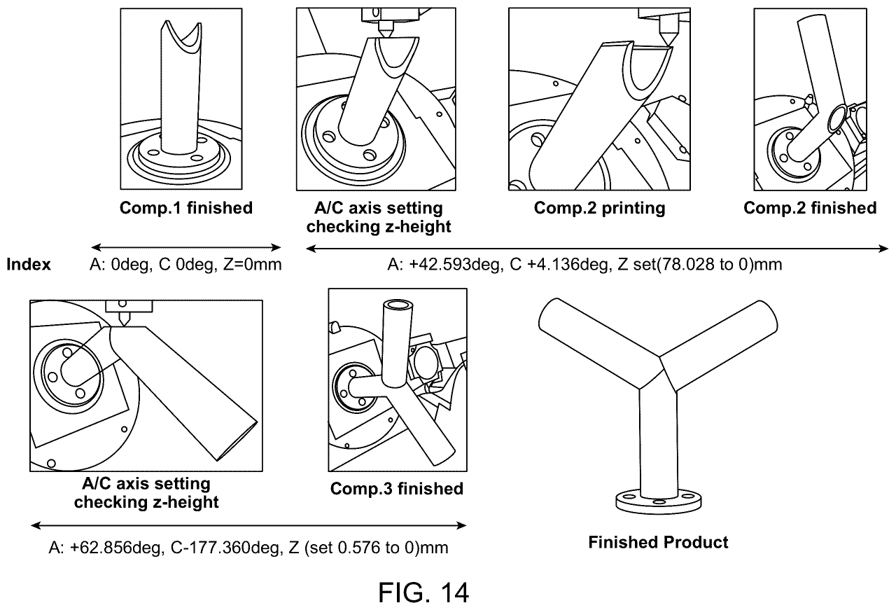

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “or” shall convey both disjunctive and conjunctive meanings. For instance, the phrase “A or B” shall be interpreted to include element A alone, element B alone, and the combination of elements A and B.

Additive manufacturing systems and methods, including three-dimensional (3D) printing systems and methods, have become prevalent over the past few years. In a 3D printing system or method, a part or component is constructed layer-by-layer, with each successive layer constructed on top of and bonded to the previous layer. Since the geometry of each layer can be individually controlled, such 3D printing systems and methods can be used to make complex parts or components that would be difficult or impossible to fabricate using conventional subtractive manufacturing methods (such as milling). However, the use of 3D printing systems and methods to make parts or components with overhanging regions has typically required the use of support structures to prevent the collapse of the overhanging regions due to gravity. Such support structures waste materials and/or may be difficult to remove from the 3D printed part or component.

Multi-axis 3D printing systems and methods (such as five-axis 3D printing systems and methods) may be coupled with beam-guided search (BGS) methods to produce 3D printed parts or components that have a significantly reduced need for support structures. Multi-axis 3D printing systems and methods allow different subvolumes of a 3D printed part or component to be successively manufactured at different rotational angles, reducing the number of overhanging regions and thereby reducing the need for support structures. BGS methods are typically used to subdivide the 3D printed part or component into such subvolumes, using clipping planes that minimize the number of overhanging regions. Such BGS methods typically use a fixed volume threshold ratio (VTR) to generate the subvolumes and clipping planes. As used herein, the VTR is defined as the ratio between the volume of a subvolume generated by the BGS procedure and the beam size utilized in the BGS procedure (which is closely correlated with the number of clipping planes generated by the BGS procedure).

However, such methods may suffer from significant limitations. For instance, using a BGS method with a relatively low VTR may yield a 3D printing process that accurately prints a part or component. However, use of such a low VTR may generate a large number of unnecessary subvolumes and/or clipping planes, greatly increasing the time required to manufacture the 3D printed part or component. On the other hand, using a BGS method with a relatively high VTR may yield a 3D printing process that fails to accurately print the part or component due to the generation of too few subvolumes and/or clipping planes. Unfortunately, there is no optimal VTR value that applies to all possible 3D printed parts or components.

Accordingly, the problem of slow 3D printing using a BGS method is addressed by systems and methods that apply variable VTR values to a BGS method, thereby generating a plurality of subvolume groups and a plurality of clipping plane groups corresponding to a model of a 3D printed part or component. Each subvolume group and clipping plane is associated with a particular VTR value and represents one possible way of printing the part or component. The plurality of subvolume groups and the plurality of clipping plane groups are presented to an operator of a 3D printing system, who can select the subvolume group and clipping plane associated with an optimal VTR value (for instance, based on experience and intuition). This may allow the operator to obtain a high-quality part or component while speeding up the 3D printing procedure.

Moreover, the problem of transforming subvolume groups and clipping plane groups generated by decomposition procedures (such as BGS) into subvolume groups and clipping plane groups that can be printed by a 3D printing systems is addressed by systems and methods that apply a coordinate transformation into a coordinate system associated with the 3D printing system.

A first computer-implemented method is presented herein. The first computer-implemented method generally comprises: receiving a model corresponding to a part to be manufactured by an additive manufacturing process; receiving a plurality of volume threshold ratio (VTR) values; and generating a subvolume group corresponding to the model and a clipping plane group corresponding to the model based on each VTR value of the plurality of VTR values, thereby generating a plurality of subvolume groups and a plurality of clipping plane groups. In some embodiments, the method further comprises displaying at least one of the plurality of subvolume groups and the plurality of clipping plane groups to a user of an additive manufacturing system. In some embodiments, generating the subvolume group corresponding to the model and the clipping plane group corresponding to the model based on each VTR value of the plurality of VTR values comprises applying a beam guided search (BGS) procedure to generate the subvolume group corresponding to the model and the clipping plane group corresponding to the model based on each VTR value of the plurality of VTR values. In some embodiments, the additive manufacturing system comprises a tiltable stage which holds the part to be manufactured. In some embodiments, the additive manufacturing system comprises a multi-axis 3D printing system. In some embodiments, the multi-axis 3D printing system comprises a five-axis 3D printing system. In some embodiments, the method further comprises selecting a selected subvolume group of the plurality of subvolume groups and a selected clipping plane group of the plurality of clipping plane groups for use in the additive manufacturing process. In some embodiments, the method further comprises receiving, from the user, a command to select a selected subvolume group of the plurality of subvolume groups and a selected clipping plane group of the plurality of clipping plane groups for use in the additive manufacturing process. In some embodiments, the method further comprises transforming the selected subvolume group and the selected clipping plane group to a transformed subvolume group and a transformed clipping plane group based on a coordinate transformation from a first coordinate system associated with the BGS procedure to a second coordinate system associated with the additive manufacturing system. In some embodiments, the coordinate transformation comprises a Horn quaternion algorithm (HQA) coordinate transformation. In some embodiments, the method further comprises performing the additive manufacturing process to thereby manufacture the part. In some embodiments, the additive manufacturing process comprises a three-dimensional (3D) printing process. In some embodiments, the 3D printing process is selected from the group consisting of: fused deposition modeling (FDM), laser metal deposition (LDM), direct metal deposition (DMD), and cold spray metal deposition (CSMD).

A second computer-implemented method is presented herein. The second computer-implemented method generally comprises: receiving a selected subvolume group and a selected clipping plane group associated with a model, the model corresponding to a part to be manufactured by an additive manufacturing process; and transforming the selected subvolume group and the selected clipping plane group to a transformed subvolume group and a transformed clipping plane group based on a coordinate transformation from a first coordinate system to a second coordinate system associated with an additive manufacturing system. In some embodiments, the coordinate transformation comprises an HQA coordinate transformation. In some embodiments, the selected subvolume group and the selected clipping plane group are generated using a BGS procedure. In some embodiments, the first coordinate system is associated with the BGS procedure. In some embodiments, the method further comprises performing the additive manufacturing process to thereby manufacture the part. In some embodiments, the additive manufacturing process comprises a 3D printing process. In some embodiments, the 3D printing process is selected from the group consisting of: FDM, LDM, DMD, and CSMD. In some embodiments, the additive manufacturing system comprises a tiltable stage which holds the part to be manufactured. In some embodiments, the additive manufacturing system comprises a multi-axis 3D printing system. In some embodiments, the multi-axis 3D printing system comprises a five-axis 3D printing system.

A first non-transitory, machine-readable medium is presented herein. The first non-transitory, machine-readable medium generally has stored thereon machine-readable instructions executable to cause a system to perform operations comprising: receiving a model corresponding to a part to be manufactured by an additive manufacturing process; receiving a plurality of VTR values; and generating a subvolume group corresponding to the model and a clipping plane group corresponding to the model based on each VTR value of the plurality of VTR values, thereby generating a plurality of subvolume groups and a plurality of clipping plane groups. In some embodiments, the operations further comprise displaying at least one of the plurality of subvolume groups and the plurality of clipping plane groups to a user of an additive manufacturing system. In some embodiments, generating the subvolume group corresponding to the model and the clipping plane group corresponding to the model based on each VTR value of the plurality of VTR values comprises applying a BGS procedure to generate the subvolume group corresponding to the model and the clipping plane group corresponding to the model based on each VTR value of the plurality of VTR values. In some embodiments, the additive manufacturing system comprises a tiltable stage which holds the part to be manufactured. In some embodiments, the additive manufacturing system comprises a multi-axis 3D printing system. In some embodiments, the multi-axis 3D printing system comprises a five-axis 3D printing system. In some embodiments, the operations further comprise selecting a selected subvolume group of the plurality of subvolume groups and a selected clipping plane group of the plurality of clipping plane groups for use in the additive manufacturing process. In some embodiments, the operations further comprise receiving, from the user, a command to select a selected subvolume group of the plurality of subvolume groups and a selected clipping plane group of the plurality of clipping plane groups for use in the additive manufacturing process. In some embodiments, the operations further comprise transforming the selected subvolume group and the selected clipping plane group to a transformed subvolume group and a transformed clipping plane group based on a coordinate transformation from a first coordinate system associated with the BGS procedure to a second coordinate system associated with the additive manufacturing system. In some embodiments, the coordinate transformation comprises an HQA coordinate transformation. In some embodiments, the operations further comprise performing the additive manufacturing process to thereby manufacture the part. In some embodiments, the additive manufacturing process comprises a 3D printing process. In some embodiments, the 3D printing process is selected from the group consisting of: FDM, LDM, DMD, and CSMD.

A second non-transitory, machine-readable medium is presented herein. The second non-transitory, machine-readable medium generally has stored thereon machine-readable instructions executable to cause a system to perform operations comprising: receiving a selected subvolume group and a selected clipping plane group associated with a model, the model corresponding to a part to be manufactured by an additive manufacturing process; and transforming the selected subvolume group and the selected clipping plane group to a transformed subvolume group and a transformed clipping plane group based on a coordinate transformation from a first coordinate system to a second coordinate system associated with an additive manufacturing system. In some embodiments, the coordinate transformation comprises an HQA coordinate transformation. In some embodiments, the selected subvolume group and the selected clipping plane group are generated using a BGS procedure. In some embodiments, the first coordinate system is associated with the BGS procedure. In some embodiments, the operations further comprise performing the additive manufacturing process to thereby manufacture the part. In some embodiments, the additive manufacturing process comprises a 3D printing process. In some embodiments, the 3D printing process is selected from the group consisting of: FDM, LDM, DMD, and CSMD. In some embodiments, the additive manufacturing system comprises a tiltable stage which holds the part to be manufactured. In some embodiments, the additive manufacturing system comprises a multi-axis 3D printing system. In some embodiments, the multi-axis 3D printing system comprises a five-axis 3D printing system.

A third computer-implemented method is presented herein. The third computer-implemented method generally comprises: receiving a model corresponding to a part to be manufactured by an additive manufacturing process; receiving a plurality of threshold values determined based on a volume of a subvolume of the part; and generating a subvolume group corresponding to the model and a clipping plane group corresponding to the model based on each threshold value of the plurality of threshold values, thereby generating a plurality of subvolume groups and a plurality of clipping plane groups.

A third non-transitory, machine-readable medium is presented herein. The third non-transitory, machine-readable medium generally has stored thereon machine-readable instructions executable to cause a system to perform operations comprising: receiving a model corresponding to a part to be manufactured by an additive manufacturing process; receiving a plurality of threshold values determined based on a volume of a subvolume of the part; and generating a subvolume group corresponding to the model and a clipping plane group corresponding to the model based on each threshold value of the plurality of threshold values, thereby generating a plurality of subvolume groups and a plurality of clipping plane groups.

### Methods for Generating Subvolume Groups and Clipping Plane Groups Using a Plurality of VTRs in a BGS Procedure

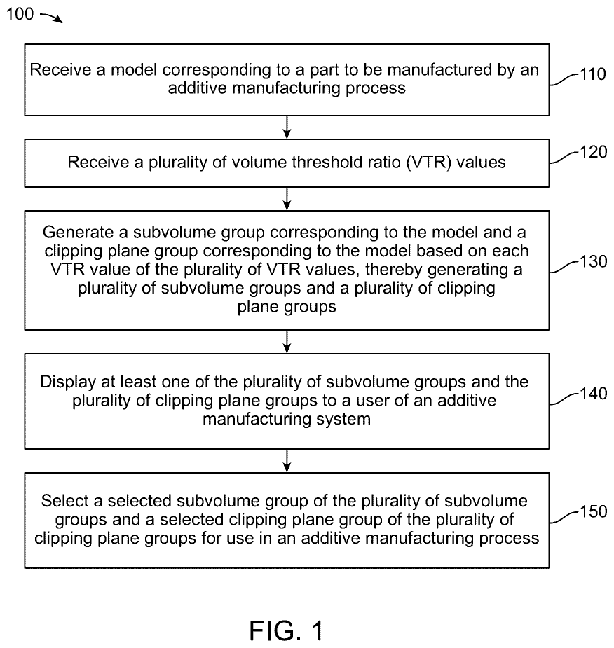

FIG. 1 shows a flowchart depicting an exemplary method for generating subvolume groups and clipping plane groups representing a model of a part or component using a plurality of VTRs in a BGS procedure. In the example shown, a model corresponding to a part or component to be manufactured by an additive manufacturing process is received at 110. In some embodiments, the additive manufacturing process comprises a 3D printing process. In some embodiments, the 3D printing process is selected from the group consisting of: fused deposition modeling (FDM), laser metal deposition (LDM), direct metal deposition (DMD), and cold spray metal deposition (CSMD).

At 120, a plurality of VTR values is received. In some embodiments, the plurality of VTR values comprises at least about 2, 3, 4, 5, 6, 7, 8, 9, 10, 20, 30, 40, 50, 60, 70, 80, 90, 100, or more VTR values, at most about 100, 90, 80, 70, 60, 50, 40, 30, 20, 10, 9, 8, 7, 6, 5, 4, 3, or 2 VTR values, or a number of VTR values that is within a range defined by any two of the preceding values.

At 130, a subvolume group corresponding to the model and a clipping plane group corresponding to the model is generated based on each VTR value of the plurality of VTR values. In some embodiments, a BGS procedure is applied to thereby generate the subvolume group corresponding to the model and the clipping plane group corresponding to the model. Once this has been performed for each VTR value, a plurality of subvolume groups and a plurality of clipping plane groups are generated.

At 140, at least one of the plurality of subvolume groups and the plurality of clipping plane groups are displayed to a user (such as an operator) of an additive manufacturing system. In some embodiments, the additive manufacturing system comprises a multi-axis additive manufacturing system (such as a multi-axis 3D printing system). In some embodiments, the additive manufacturing system comprises a 4-axis, 5-axis, or 6-axis additive manufacturing system (such as a 4-axis, 5-axis, or 6-axis) 3D printing system. In some embodiments, the additive manufacturing system has at least 1, 2, or 3 rotational degrees of freedom (RDOFs), at most about 3, 2, or 1 RDOFs, or a number of RDOFs that is within a range defined by any two of the preceding values. In some embodiments, the additive manufacturing system comprises a tiltable stage which holds the part to be manufactured.

At 150, a selected subvolume group of the plurality of subvolume groups and a selected clipping plane group of the plurality of clipping plane groups are selected for use in the additive manufacturing process. In some embodiments, the selected subvolume group and the selected clipping plane group are determined by receiving a command from the user. For instance, in some embodiments, the user examines the plurality of subvolume groups and the plurality of clipping plane groups to determine which subvolume group and clipping plane group will optimize the 3D printing process. In some embodiments, the user makes such a determination based on experience and intuition.

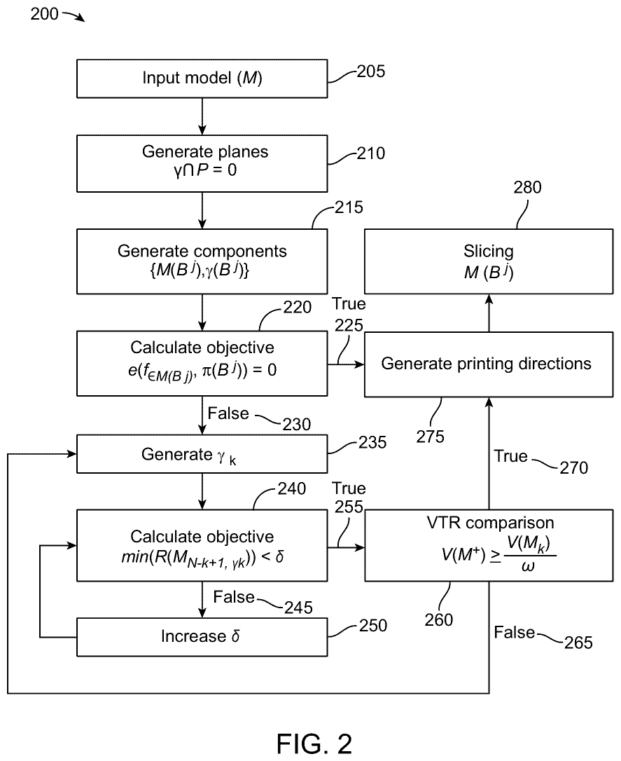

FIG. 2 shows an exemplary BGS procedure 200 associated with a single VTR value. In some embodiments, the BGS procedure 200 is applied to each VTR value of the plurality of VTR values described herein with respect to FIG. 1 to thereby generate the plurality of subvolume groups and the plurality of clipping plane groups described herein with respect to FIG. 1. In the example shown, an input model M is received by the BGS procedure at 205. In some embodiments, the input model M corresponds to a part or component manufactured by an additive manufacturing process, as described herein with respect to FIG. 1. In some embodiments, the input model M may be decomposed into N components Mᵢ (i=1, . . . , N) (also referred to as subvolume groups herein) associated with N planes πᵢ (i=1, . . . , N) according to Equations (1) and (2):

M=∪ᵢ₌₁^{N}Mᵢ (1)

πᵢ₊₁=Mᵢ₊₁∩(∪ⱼ₌₁ⁱMⱼ) (2)

In some embodiments, πᵢ is an intersection plane that belongs to both Mᵢ and Mᵢ₋₁. For instance, in some embodiments, π₁ is a working plane of an additive manufacturing system, π₂=M₂∩M₁, π₃=M₃∩(M₁∪M₂), and so forth. In some embodiments, the goal of the BGS procedure is to find the components Mᵢ and associated clipping plane groups described herein that allow the input model M to be printed in a manner that permits overhanging regions to be printed without the need for support structures.

At 210, planes γ are generated. In some embodiments, only planes γ that do not intersect with a printing platform P of an additive manufacturing system are selected from the set of planes πᵢ (i=1, . . . , N). That is, in some embodiments, γ∩P=0 for all generated planes γ.

At 215, subvolume components M(B^{j}) are generated from the model M as a result of a slicing by the clipping plane γ(B^{j}). The generated subvolume component-clipping plane pairs (M(B^{j}),γ(B^{j})) are stored in beam set B^{j} (j=1, . . . , b), where b is the beam set size.

At 220, an objective function e(f_{∈M(B}_{^{j}}₎,π(B^{j})) is calculated to determine whether printing the component in a given direction is risky or safe. Printing the component in a particular direction is considered to be safe if the component is well-supported. In all other cases, printing the component in that particular direction is considered to be risky. The objective function e(M(B^{j}),π(B^{j})) is calculated according to Equation (3):

$$e ( {f}_{∈ M ( {B}^{j} )} , π ( {B}^{j} ) ) = \{ \begin{matrix}1 , & {n}_{f ∈ M ( {B}^{j} )} \cdot {d}_{π} + sin ( {a}_{max} ) < 0 \\ 0 , & otherwise\end{matrix} \qquad ( 3 )$$

Here, n_{f} are the normals to the faces of component M(B^{j}), d_{π} are the printing directions associated with planes π(B^{j}), and αₘₐₓ is the maximum self-supporting angle for the component.

At 225, if e(M(B^{j}),π(B^{j}))=0, printing the component in the given direction is considered to be safe and the process proceeds to 275, as described herein.

At 230, if e(M(B^{j}),π(B^{j}))≠0, printing the component in the given direction is considered to be risky and the process proceeds to 235, as described herein.

At 235, clipping planes γₖ are generated. In some embodiments, γₖ are clipping planes that were selected from planes πᵢ generated as described herein (i.e., planes generated to satisfy γ∩P=0, as described herein).

At 240, an objective function R(M_{N-k+1},γₖ) is minimized and compared to a threshold value δ. The objective function R(M_{N-k+1},γₖ) is calculated according to Equation (4):

R(M_{N-k+1},γₖ)=Σ_{f∈M}_{_{N}}₋ₖ₊₁e(f,π(γ))A(f) (4)

Here, A(f) is the area of face f. In some embodiments, minimization of the objective function R(M_{N-k+1},γₖ) selects optimal clipping planes γₖ.

At 245, if the minimized objective function R(M_{N-k+1},γₖ) exceeds the threshold value δ, the threshold value δ is increased at 250 and the process returns to 240.

At 255, if the minimized objective function R(M_{N-k+1},γₖ) is smaller than the threshold value δ, the process proceeds to 260, as described herein.

At 260, V(M⁺), the volume of the input model M above the clipping plane, is compared with V(Mₖ)/ω, the VTR. Here, V(Mₖ) the volume of model component Mₖ and ω is the beam size, which is closely correlated with the number of clipping planes generated by the BGS procedure.

At 265, if V(M⁺)<V(Mₖ)/ω, the process proceeds to 235 and repeats the steps following 235, as described herein.

At 270, if V(M⁺)≥V(Mₖ)/ω, the process proceeds to 275.

At 275, printing directions are generated based on the clipping planes.

At 280, the input model is sliced according to M(B^{j}).

As described herein, in some embodiments, the BGS procedure 200 is repeated for each VTR value of the plurality of VTR values described herein with respect to FIG. 1 to thereby generate the plurality of subvolume groups and the plurality of clipping plane groups described herein with respect to FIG. 1.

Table 1 shows exemplary pseudo code for a computer program capable of implementing the BGS procedure 200 described herein with respect to FIG. 1.

TABLE 1
Pseudo code for the VTR BGS procedure 200 described herein with
respect to FIG. 1:

```
%% Input: sequence of M(B^{j})
%% Output: well-optimized component
For all (M(B^{j}), γ(B^{j}))
  %% Searching optimized component for VTR values
  For VTR = 0.01:n
    $If \frac{V [ M ( {B}^{j} ) ]}{V [ M ]} \leq V T R$
      Mₛ = M(B^{j}) and γₛ = γ(B^{j})
      Store the decomposed components Mₛ and their associated clipping
      plane γₛ into the beam b
      End if
    End for
End for
```

### Methods for Transforming a Subvolume Group and Clipping Plane Group From a First Coordinate System to a Second Coordinate System

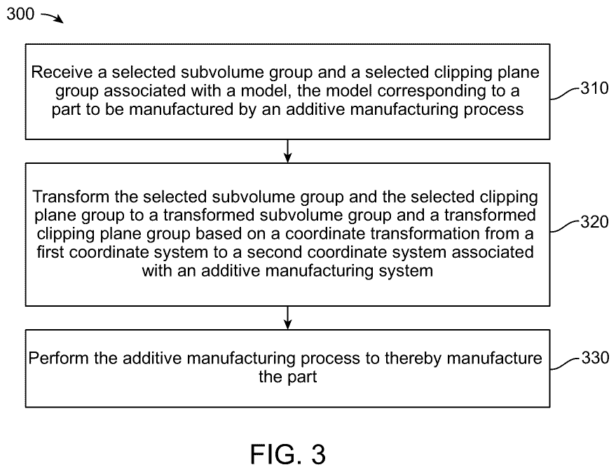

FIG. 3 shows a flowchart depicting an exemplary method for transforming a subvolume group and clipping plane group from a first coordinate system to a second coordinate system. In the example shown, a selected subvolume group and a selected clipping plane group are received at 310. In some embodiments, the model corresponds to a part to be manufactured by an additive manufacturing process. In some embodiments, the additive manufacturing process comprises a 3D printing process. In some embodiments, the 3D printing process is selected from the group consisting of: FDM, LDM, DMD, and CSMD.

At 320, the selected subvolume group and the selected clipping plane group are transformed to a transformed subvolume group and a transformed clipping plane group. In some embodiments, the selected subvolume group and the selected clipping plane group are transformed based on a coordinate transformation from a first coordinate system to a second coordinate system. In some embodiments, the selected subvolume group and the selected clipping plane group are generated using a BGS procedure (such as a BGS procedure described herein with respect to FIGS. 1 and/or 2). In some embodiments, the first coordinate system is associated with a BGS procedure (such as a BGS procedure described herein with respect to FIGS. 1 and/or 2). In some embodiments, the second coordinate system is associated with an additive manufacturing system. In some embodiments, the additive manufacturing system comprises a multi-axis additive manufacturing system (such as a multi-axis 3D printing system). In some embodiments, the additive manufacturing system comprises a 4-axis, 5-axis, or 6-axis additive manufacturing system (such as a 4-axis, 5-axis, or 6-axis 3D printing system). In some embodiments, the additive manufacturing system has at least 1, 2, or 3 RDOFs, at most about 3, 2, or 1 RDOFs, or a number of RDOFs that is within a range defined by any two of the preceding values. In some embodiments, the additive manufacturing systems comprises a tiltable stage which holds the part to be manufactured.

In some embodiments, the coordinate transformation comprises a Horn quaternion algorithm (HQA) coordinate transformation. In some embodiments, the HQA transformation calculates rotation angles to transform a normal vector associated with each clipping plane in the selected clipping plane group into a representation in the additive manufacturing system coordinate system. In some embodiments, the HQA transformation calculates the rotation angles as yaw, roll, and pitch rotation angles. In some embodiments, the clipping planes of the selected clipping plane group are represented in the first coordinate system by the plane equation Pₓᵢx+P_{yi}y+P_{zi}z−P₀ᵢ=0 for i=1, . . . , N, where N is the number of clipping planes in the selected clipping plane group. In some embodiments, the transformed clipping planes are represented in the second coordinate system by the plane equation Qₓᵢx+Q_{yi}y+Q_{zi}z−Q₀ᵢ=0. In the case of an additive manufacturing process conducted using a 4-axis, 5-axis, or 6-axis additive manufacturing system, the normal vector to each transformed clipping plane will generally point along the z direction, such that the transformed clipping planes may be represented in the second coordinate system by the plane equation Q_{zi}z−Q₀ᵢ=0.

Given a plane P={p₁, p₂, . . . , pₙ} composed of points p₁, p₂, . . . , pₙ in the first coordinate system and a plane Q={q₁, q₂, . . . , qₙ} a composed of points q₁, q₂, . . . , qₙ in the second coordinate system, an optimal rigid rotation matrix R may be computed via least squares minimization according to Equation (5):

[R]=argmin Σᵢ₌₁ⁿωᵢ||Rpᵢ−qᵢ||² (5)

Here, ωᵢ is the weight associated with point pair {pᵢ, qᵢ}. Assuming pᵢ=pᵢ(xi) and qᵢ=qᵢ(yᵢ) and noting that R^{T}R=I (where I is the identity matrix) and yᵢ^{T}Rxᵢ=xᵢ^{T}R^{T}yᵢ:

$$\begin{matrix}{‖ {Rx}_{i} - {y}_{i} ‖}^{2} = {( {Rx}_{i} - {y}_{i} )}^{T} ( R {x}_{i} - {y}_{i} ) \\ = ( {x}_{i}^{T} {R}^{T} - {y}_{i}^{T} ) ( {Rx}_{i} - {y}_{i} ) \\ = {x}_{i}^{T} {R}^{T} R {x}_{i} - {y}_{i}^{T} {Rx}_{i} - {x}_{i}^{T} {R}^{T} {y}_{i} + {y}_{i}^{T} {y}_{i}\end{matrix} \qquad ( 6 )$$

$$= {x}_{i}^{T} {x}_{i} - {y}_{i}^{T} {Rx}_{i} - {x}_{i}^{T} {R}^{T} {y}_{i} + {y}_{i}^{T} {y}_{i}$$

$${‖ {Rx}_{i} - {y}_{i} ‖}^{2} = {x}_{i}^{T} {x}_{i} - 2 {y}_{i}^{T} R {x}_{i} + {y}_{i}^{T} {y}_{i}$$

Combining Equations (5) and (6), and noting that argmin Σᵢ₌₁ⁿωᵢxᵢ^{T}xᵢ=argmin Σᵢ₌₁ⁿωᵢyᵢ^{T}yᵢ=0 and that the leading coefficient is irrelevant to the minimization procedure:

$$\begin{matrix}[ R ] = argmin {\sum }_{i = 1}^{n} {ω}_{i} {y}_{i}^{T} {Rx}_{i} \\ = argmin Trace ( {WY}^{T} RX )\end{matrix} \qquad ( 7 )$$

$$[ R ] = argmin Trace ( {RXWY}^{T} )$$

Denoting S=U∇V^{T}:

$$\begin{matrix}[ R ] = argmin Trace ( {RXWY}^{T} ) \\ = argmin Trace ( RS ) \\ = argmin Trace ( RU ∇ {V}^{T} )\end{matrix} \qquad ( 8 )$$

$$[ R ] = argmin Trace ( ∇ {V}^{T} RU )$$

Note that ∇, V^{T}, and R are all orthogonal matrices, and thus that M=∇V^{T}R=M(mᵢⱼ) is also an orthogonal matrix. Thus, the columns of M are orthonormal vectors:

M^{T}M=Σᵢ₌₁ⁿmᵢⱼ²,(mᵢⱼ²≤1) (9)

Combining Equations (8) and (9):

$$\begin{matrix}[ R ] = argmin {\sum }_{i = 1}^{n} {ω}_{i} {y}_{{i}^{T}} R {x}_{i} \\ = argmin Trace ( ∇ {V}^{T} R U ) \\ = argmin Trace ( ∇ M )\end{matrix} \qquad ( 10 )$$

$$[ R ] = {\sum }_{i = 1}^{d} {σ}_{i} {m}_{i i} \leq {\sum }_{i = 1}^{d} {σ}_{i}$$

The trace is maximized if mᵢᵢ=1. Since M is orthogonal, this means that M is an identity matrix and that V^{T}RU=M=I. Thus, V=RU and the rotation matrix R that maps from plane P to plane Q is given by:

R=VU^{T} (11)

At 330, the additive manufacturing process is performed to thereby manufacture the part or component.

Table 2 shows exemplary Matlab code for a computer program capable of implementing the coordinate transformation procedure 300 described herein with respect to FIG. 3.

TABLE 2
Matlab code for the coordinate transformation procedure 300 described herein with
respect to FIG. 3:

```
function [R]=HQA(P,Q,varargin)
  % P: 3xN matrix whose columns are the coordinates of N source points.
  % Q: 3xN matrix whose columns are the coordinates of N target points.
  % solves and align two different planes by solving the minimization equation:
  % min. sum_i w(i)*||w*R*P(:,i) + t − Q(:,i)||\hat{ }2
  % where w is the weights for the pair points P and Q.
  Dim = size(P,1);
  if dim ~= size(Q,1),
    error ‘P and Q should be of same size’
  end
  % Compute centroids and weights:
  Lc = mean(P,2); rc=mean(B,2); % Centroids
  leftW = matmvec(P,lc); % Center coordinates at centroids
  rightW = matmvec(Q,rc);
  M=leftW*rightW.’;
  % Compute rotation matrix R.
  Nxx=M(1)+M(4); Nyx=M(3)−M(2);
  N=[Nxx Nyx;Nyx −Nxx];
  [V,D]=eig(N);
  [emax] = max(real(diag(D))); emax=emax(1);
  q = V(:,emax); % Get eigenvector corresponding to maximum eigenvalue
  q = real(q); % Get rid of imaginary part caused by numerical error
  q = q*sign(q(2)+(q(2)>=0)); % Sign ambiguity
  q = q./norm(q);
  R11 = q(1)\hat{ }2-q(2)\hat{ }2;
  R21 = prod(q)*2;
  R = [R11 −R21;R21 R11]; % Map to orthogonal matrix
  [Sxx,Syx,Szx, Sxy,Syy,Szy, Sxz,Syz,Szz] = dealr(M(:));
  N = [(Sxx+Syy+Szz) (Syz−Szy) (Szx−Sxz) (Sxy−Syx);...
    (Syz−Szy) (Sxx−Syy−Szz) (Sxy+Syx) (Szx+Sxz);...
    (Szx−Sxz) (Sxy+Syx) (−Sxx+Syy−Szz) (Syz+Szy);...
    (Sxy−Syx) (Szx+Sxz) (Syz+Szy) (−Sxx−Syy+Szz)];
  [V,D] = eig(N);
  [emax] = max(real(diag(D))); emax = emax(1);
  q = V(:,emax); % Get eigenvector corresponding to maximum eigenvalue
  q = real(q); % Get rid of imaginary part caused by numerical error
  [ii] = max(abs(q)); sgn = sign(q(ii(1)));
  q = q*sgn; % Sign ambiguity
  quat = q(:);
  nrm = norm(quat);
  if ~nrm
    disp ‘Quaternion distribution is 0’
  end
  quat = quat./norm(quat);
  q0 = quat(1);
  qx = quat(2);
  qy = quat(3);
  qz = quat(4);
  v = quat(2:4);
  Z = [q0 −qz qy;...
    qz q0 −qx;...
    −qy qx q0 ];
  R = v*v.’ + Z\hat{ }2;
  disp ‘Rotation matrix is R = ’
end
```

In some embodiments, any two or three of the method 100 described herein with respect to FIG. 1, the method 200 described herein with respect to FIG. 2, and the method 300 described herein with respect to FIG. 3 are combined. For instance, in some embodiments, the selected subvolume group and the selected clipping plane group generated at step 150 of method 100 constitute the selected subvolume group and the selected clipping plane group received at step 310 of method 300.

### Computer Systems

Additionally, systems are disclosed that can be used to perform the method 100 of FIG. 1, the method 200 of FIG. 2, the method 300 of FIG. 3, or any of operations 110, 120, 130, 140, and 150, or any of operations 205, 210, 215, 220, 225, 230, 235, 240, 245, 250, 255, 260, 265, 270, 275, and 280, or any of operations 310, 320, and 330. In some embodiments, the systems comprise one or more processors and memory coupled to the one or more processors. In some embodiments, the one or more processors are configured to implement one or more operations of method 100, 200, and/or 300. In some embodiments, the memory is configured to provide the one or more processors with instructions corresponding to the operations of method 100, 200, and/or 300. In some embodiments, the instructions are embodied in a tangible computer readable storage medium.

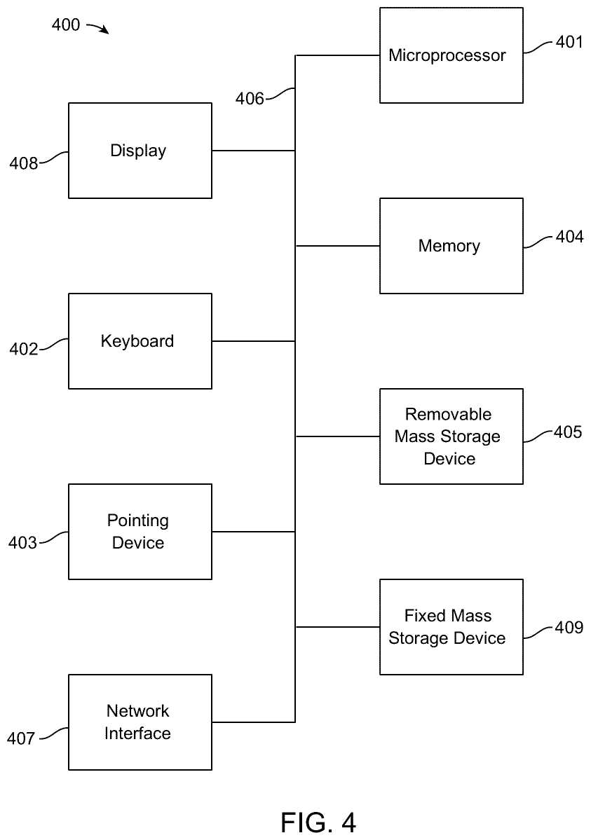

FIG. 4 is a block diagram of a computer system 400 used in some embodiments to perform all or portions of methods 100, 200, and/or 300 described herein (such as operations 110, 120, 130, 140, and/or 150 of method 100 as described herein with respect to FIG. 1, operations 205, 210, 215, 220, 225, 230, 235, 240, 245, 250, 255, 260, 265, 270, 275, and/or 280 of method 200 as described herein with respect to FIG. 2, and/or operations 310, 320, and/or 330 of method 300 as described herein with respect to FIG. 3). In some embodiments, the computer system may be utilized as a component in systems for performing the methods of FIGS. 1, 2, and/or 3 described herein. FIG. 4 illustrates one embodiment of a general purpose computer system. Other computer system architectures and configurations can be used for carrying out the processing of the present invention. Computer system 400, made up of various subsystems described below, includes at least one microprocessor subsystem 401. In some embodiments, the microprocessor subsystem comprises at least one central processing unit (CPU) or graphical processing unit (GPU). The microprocessor subsystem can be implemented by a single-chip processor or by multiple processors. In some embodiments, the microprocessor subsystem is a general purpose digital processor which controls the operation of the computer system 400. Using instructions retrieved from memory 404, the microprocessor subsystem controls the reception and manipulation of input data, and the output and display of data on output devices.

The microprocessor subsystem 401 is coupled bi-directionally with memory 404, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. It can also store programming instructions and data, in the form of data objects and text objects, in addition to other data and instructions for processes operating on microprocessor subsystem. Also as well known in the art, primary storage typically includes basic operating instructions, program code, data and objects used by the microprocessor subsystem to perform its functions. Primary storage devices 404 may include any suitable computer-readable storage media, described below, depending on whether, for example, data access needs to be bi-directional or uni-directional. The microprocessor subsystem 401 can also directly and very rapidly retrieve and store frequently needed data in a cache memory (not shown).

A removable mass storage device 405 provides additional data storage capacity for the computer system 400, and is coupled either bi-directionally (read/write) or uni-directionally (read only) to microprocessor subsystem 401. Storage 405 may also include computer-readable media such as magnetic tape, flash memory, signals embodied on a carrier wave, PC-CARDS, portable mass storage devices, holographic storage devices, and other storage devices. A fixed mass storage 409 can also provide additional data storage capacity. The most common example of mass storage 409 is a hard disk drive. Mass storage 405 and 409 generally store additional programming instructions, data, and the like that typically are not in active use by the processing subsystem. It will be appreciated that the information retained within mass storage 405 and 409 may be incorporated, if needed, in standard fashion as part of primary storage 404 (e.g. RAM) as virtual memory.

In addition to providing processing subsystem 401 access to storage subsystems, bus 406 can be used to provide access other subsystems and devices as well. In the described embodiment, these can include a display monitor 408, a network interface 407, a keyboard 402, and a pointing device 403, as well as an auxiliary input/output device interface, a sound card, speakers, and other subsystems as needed. The pointing device 403 may be a mouse, stylus, track ball, or tablet, and is useful for interacting with a graphical user interface.

The network interface 407 allows the processing subsystem 401 to be coupled to another computer, computer network, or telecommunications network using a network connection as shown. Through the network interface 407, it is contemplated that the processing subsystem 401 might receive information, e.g., data objects or program instructions, from another network, or might output information to another network in the course of performing the above-described method steps. Information, often represented as a sequence of instructions to be executed on a processing subsystem, may be received from and outputted to another network, for example, in the form of a computer data signal embodied in a carrier wave. An interface card or similar device and appropriate software implemented by processing subsystem 401 can be used to connect the computer system 400 to an external network and transfer data according to standard protocols. That is, method embodiments of the present invention may execute solely upon processing subsystem 401, or may be performed across a network such as the Internet, intranet networks, or local area networks, in conjunction with a remote processing subsystem that shares a portion of the processing. Additional mass storage devices (not shown) may also be connected to processing subsystem 401 through network interface 407.

An auxiliary I/O device interface (not shown) can be used in conjunction with computer system 400. The auxiliary I/O device interface can include general and customized interfaces that allow the processing subsystem 401 to send and, more typically, receive data from other devices such as microphones, touch-sensitive displays, transducer card readers, tape readers, voice or handwriting recognizers, biometrics readers, cameras, portable mass storage devices, and other computers.

In addition, embodiments of the present invention further relate to computer storage products with a computer readable medium that contains program code for performing various computer-implemented operations. The computer-readable medium is any data storage device that can store data which can thereafter be read by a computer system. The media and program code may be those specially designed and constructed for the purposes of the present invention, or they may be of the kind well known to those of ordinary skill in the computer software arts. Examples of computer-readable media include, but are not limited to, all the media mentioned above: magnetic media such as hard disks, floppy disks, and magnetic tape; optical media such as CD-ROM disks; magneto-optical media such as floptical disks; and specially configured hardware devices such as application-specific integrated circuits (ASICs), programmable logic devices (PLDs), and ROM and RAM devices. The computer-readable medium can also be distributed as a data signal embodied in a carrier wave over a network of coupled computer systems so that the computer-readable code is stored and executed in a distributed fashion. Examples of program code include both machine code, as produced, for example, by a compiler, or files containing higher level code that may be executed using an interpreter. The computer system shown in FIG. 4 is but an example of a computer system suitable for use with the invention. Other computer systems suitable for use with the invention may include additional or fewer subsystems. In addition, bus 406 is illustrative of any interconnection scheme serving to link the subsystems. Other computer architectures having different configurations of subsystems may also be utilized.

### EXAMPLES

### Example 1: Slicing of L-Pipe Using BGS and a Plurality of VTRs

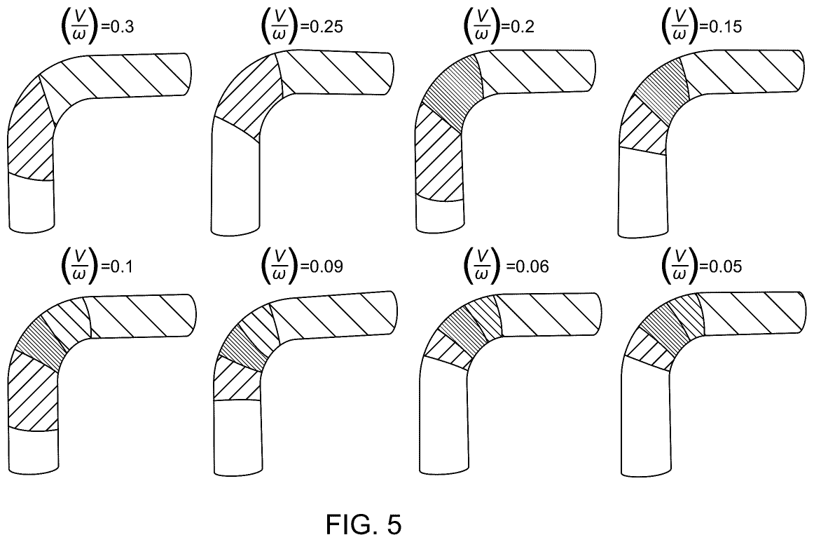

FIG. 5 shows an exemplary slicing of an L-pipe using BGS and a plurality of VTRs. The L-pipe formed the input model to the variable VTR BGS procedure described herein. An αₘₐₓ value of 0.342 (corresponding to a maximum self-supported angle of 20 degrees) was utilized in the BGS procedure. Subvolume groups and clipping plane groups were generated using the BGS procedure for VTR values of 0.3, 0.25, 0.2, 0.15, 0.1, 0.09, 0.06, and 0.05. The various subvolume groups generated by the BGS procedure for each VTR value are represented as different shaded areas in the L-pipe. Operator experience and intuition was used to determine that the subvolume group and clipping plane group associated with a VTR value of 0.05 would yield an optimized 3D printing process. As shown in FIG. 5, V refers to the volume of a subvolume generated by the BGS procedure, w refers to the beam size utilized in the BGS procedure, and V/ω refers to the VTR.

### Example 2: Slicing of Y-Pipe Using BGS and a Plurality of VTRs

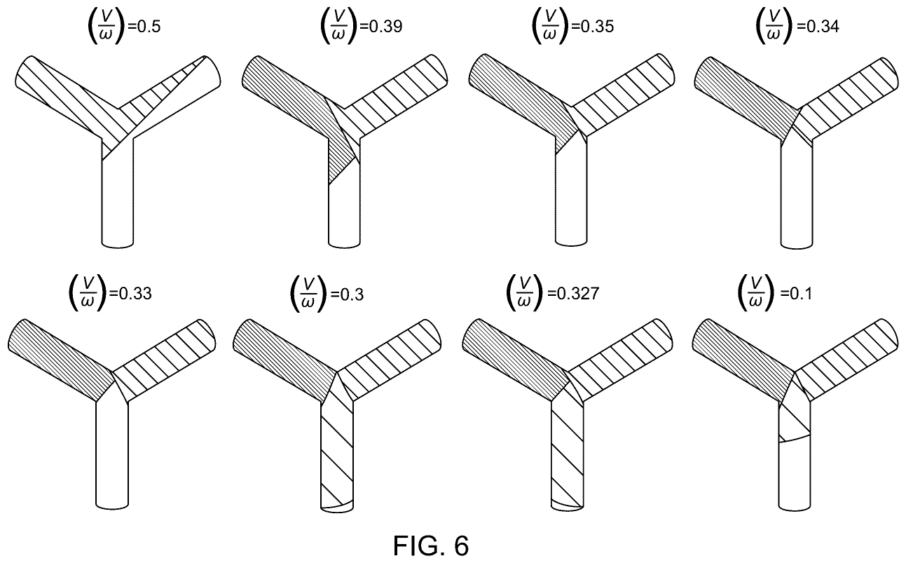

FIG. 6 shows an exemplary slicing of a Y-pipe using BGS and a plurality of VTRs. The Y-pipe formed the input model to the variable VTR BGS procedure described herein. An αₘₐₓ value of 0.342 (corresponding to a maximum self-supported angle of 20 degrees) was utilized in the BGS procedure. Subvolume groups and clipping plane groups were generated using the BGS procedure for VTR values of 0.5, 0.39, 0.35, 0.34, 0.33, 0.3, 0.327, and 0.1. The various subvolume groups generated by the BGS procedure for each VTR value are represented as different shaded areas in the Y-pipe. Operator experience and intuition was used to determine that the subvolume group and clipping plane group associated with a VTR value of 0.33 would yield an optimized 3D printing process. As shown in FIG. 6, V refers to the volume of a subvolume generated by the BGS procedure, ω refers to the beam size utilized in the BGS procedure, and V/ω refers to the VTR.

### Example 3: Slicing of 4-Way Pipe Using BGS and a Plurality of VTRs

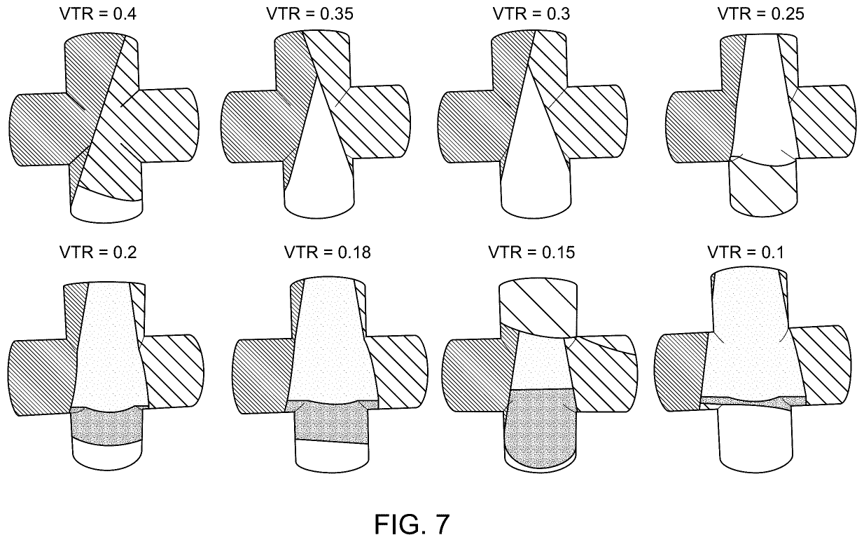

FIG. 7 shows an exemplary slicing of a four-way pipe using BGS and a plurality of VTRs. The four-way pipe formed the input model to the variable VTR BGS procedure described herein. An αₘₐₓ value of 0.342 (corresponding to a maximum self-supported angle of 20 degrees) was utilized in the BGS procedure. Subvolume groups and clipping plane groups were generated using the BGS procedure for VTR values of 0.4, 0.35, 0.3, 0.25, 0.2, 0.18, 0.15, 0.1. The various subvolume groups generated by the BGS procedure for each VTR value are represented as different shaded areas in the four-way pipe. Operator experience and intuition was used to determine that the subvolume group and clipping plane group associated with a VTR value of 0.25 would yield an optimized 3D printing process.

### Example 4: Slicing of 120 Degree Bend Pipe Using BGS and a Plurality of VTRs

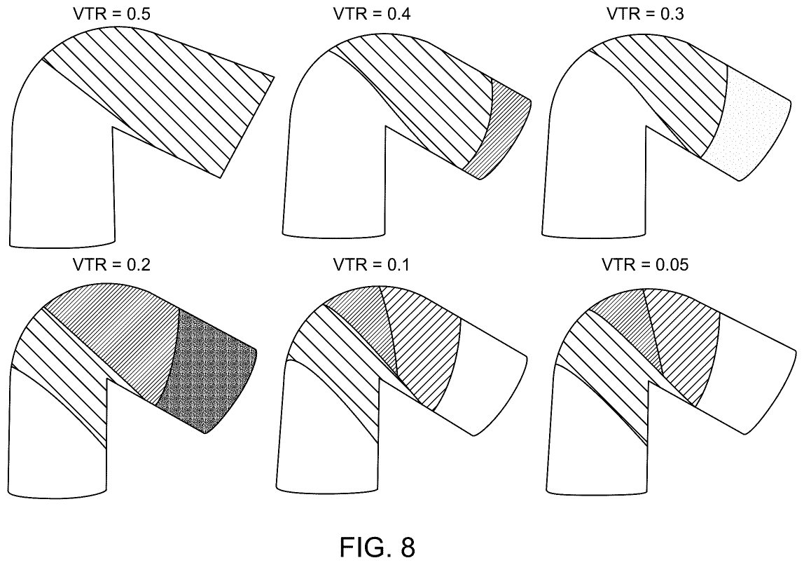

FIG. 8 shows an exemplary slicing of a 120 degree bend pipe using BGS and a plurality of VTRs. The 120 degree bend pipe formed the input model to the variable VTR BGS procedure described herein. An αₘₐₓ value of 0.342 (corresponding to a maximum self-supported angle of 20 degrees) was utilized in the BGS procedure. Subvolume groups and clipping plane groups were generated using the BGS procedure for VTR values of 0.5, 0.4, 0.3, 0.2, 0.1, and 0.05. The various subvolume groups generated by the BGS procedure for each VTR value are represented as different shaded areas in the 120 degree bend pipe. Operator experience and intuition was used to determine that the subvolume group and clipping plane group associated with a VTR value of 0.1 would yield an optimized 3D printing process.

### Example 5: Slicing of 3-Way Pipe Using BGS and a Plurality of VTRs

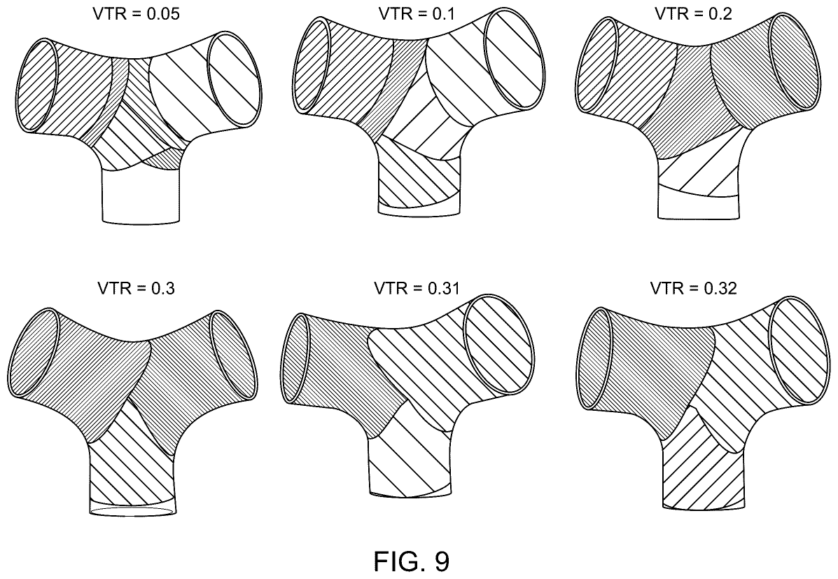

FIG. 9 shows an exemplary slicing of a 3-way pipe using BGS and a plurality of VTRs. The 3-way pipe formed the input model to the variable VTR BGS procedure described herein. An αmax value of 0.342 (corresponding to a maximum self-supported angle of 20 degrees) was utilized in the BGS procedure. Subvolume groups and clipping plane groups were generated using the BGS procedure for VTR values of 0.05, 0.1, 0.2, 0.3, 0.3, and 0.32. The various subvolume groups generated by the BGS procedure for each VTR value are represented as different shaded areas in the 3-way pipe. Operator experience and intuition was used to determine that the subvolume group and clipping plane group associated with a VTR value of 0.32 would yield an optimized 3D printing process.

### Example 6: Slicing of Octopus Using BGS and a Plurality of VTRs

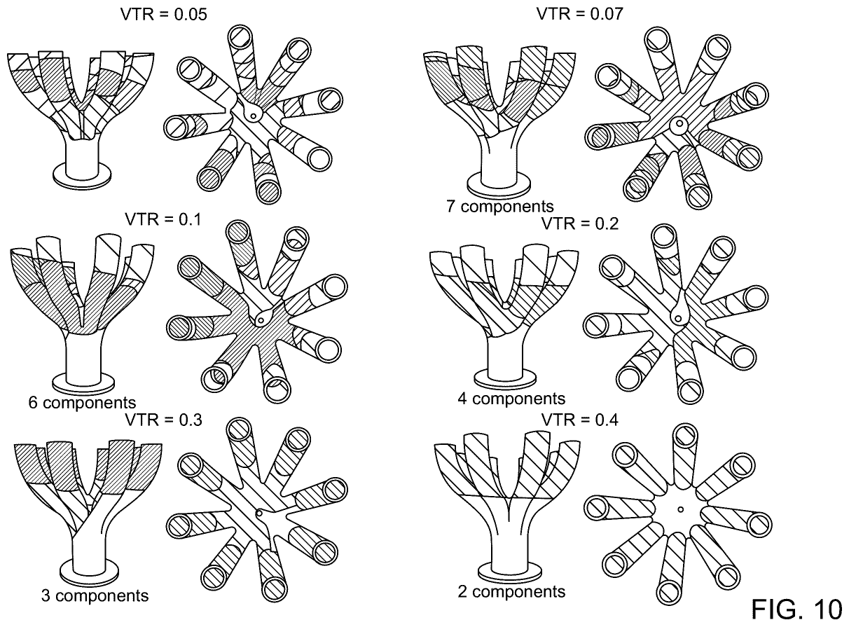

FIG. 10 shows an exemplary slicing of an octopus figure using BGS and a plurality of VTRs. The octopus formed the input model to the variable VTR BGS procedure described herein. An αₘₐₓ value of 0.342 (corresponding to a maximum self-supported angle of 20 degrees) was utilized in the BGS procedure. Subvolume groups and clipping plane groups were generated using the BGS procedure for VTR values of 0.05, 0.07, 0.1, 0.2, 0.3, and 0.4. The various subvolume groups generated by the BGS procedure for each VTR value are represented as different shaded areas in the octopus. Operator experience and intuition was used to determine that the subvolume group and clipping plane group associated with a VTR value of 0.2 would yield an optimized 3D printing process.

### Example 7: Transformation of L-Pipe Subvolumes from BGS to FDM Coordinate System

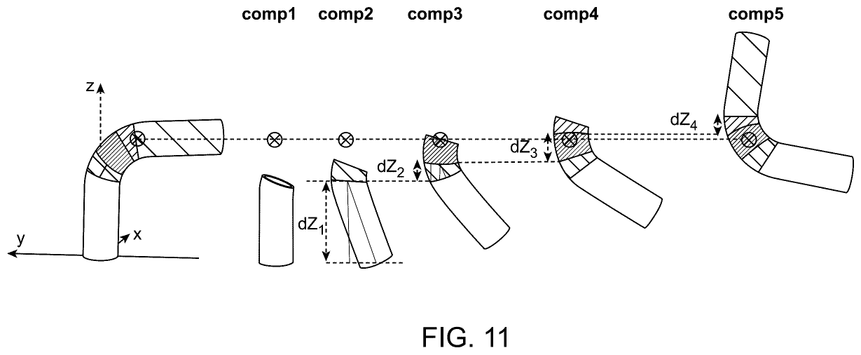

FIG. 11 shows exemplary transformations from the BGS coordinate system to the FDM coordinate system for the L-pipe of FIG. 5. The various subvolumes (labeled as comp1, comp2, comp3, comp4, and comp5) were generated using the variable VTR BGS procedure described herein, as discussed with respect to FIG. 5. Each subvolume was rotated or displaced by angles dA (rotation about z-axis), dC (rotation about x-axis), and dZ (build z height) to allow fabrication of the L-pipe on a FDM 3D printing system. Table 3 shows the rotation angles associated with transforming the L-pipe subvolumes from the BGS coordinate system to the FDM coordinate system.

TABLE 3
Rotation angles associated with transformation of L-pipe subvolumes
from BGS coordinate system to FDM coordinate system

| | Comp1 | Comp2 | Comp3 | Comp4 | Comp5 |
|---|---|---|---|---|---|
| dA | 0 | 23.8613 | 42.9639 | 58.2651 | 79.5588 |
| dC | 0 | −63.1334 | −68.1352 | −73.0132 | −84.3549 |
| dZ | 66.6755 | 0.1731 | 2.4717 | 18.2826 | |

### Example 8: Transformation of Y-Pipe Subvolumes from BGS to FDM Coordinate System

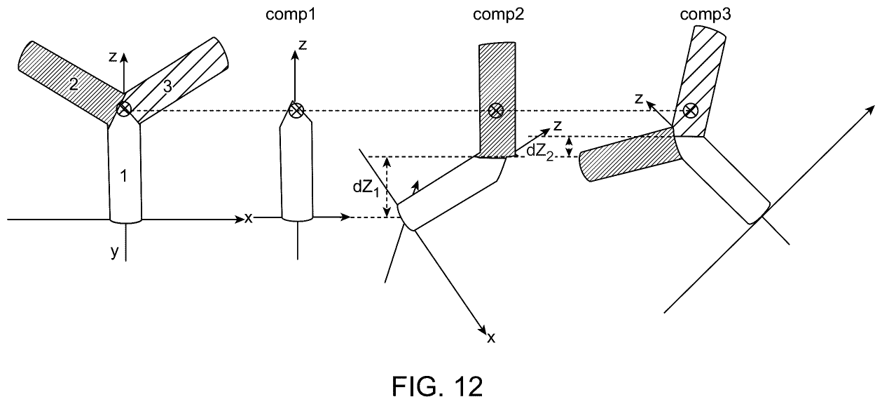

FIG. 12 shows exemplary transformations from the BGS coordinate system to the FDM coordinate system for the Y-pipe of FIG. 6. The various subvolumes (labeled as comp1, comp2, and comp3) were generated using the variable VTR BGS procedure described herein, as discussed with respect to FIG. 6. Each subvolume was rotated or displaced by angles dA (rotation about z-axis), dC (rotation about x-axis), and dZ (build z height) to allow fabrication of the Y-pipe on a FDM 3D printing system. Table 4 shows the rotation angles associated with transforming the Y-pipe subvolumes from the BGS coordinate system to the FDM coordinate system.

TABLE 4
Rotation angles associated with transformation of Y-pipe subvolumes
from BGS coordinate system to FDM coordinate system

| | Comp1 | Comp2 | Comp3 |
|---|---|---|---|
| dA | 0 | 60.8536 | −47.1196 |
| dC | 0 | −75.1455 | −69.4554 |
| dZ | 54.602782 | 17.2324 | |

### Example 9: Transformation of L-Pipe Subvolumes from BGS to FDM Coordinate System

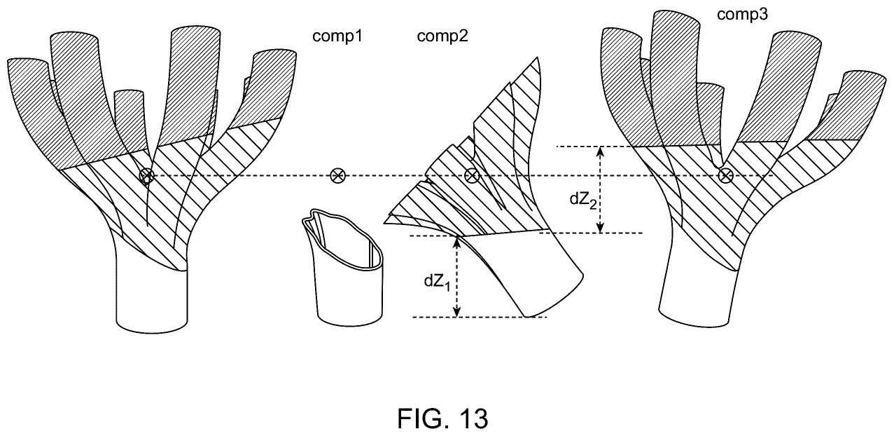

FIG. 13 shows exemplary transformations from the BGS coordinate system to the FDM coordinate system for the octopus of FIG. 10. The various subvolumes (labeled as comp1, comp2, and comp3) were generated using the variable VTR BGS procedure described herein, as discussed with respect to FIG. 10. Each subvolume was rotated or displaced by angles dA (rotation about z-axis), dC (rotation about x-axis), and dZ (build z height) to allow fabrication of the octopus on a FDM 3D printing system. Table 5 shows the rotation angles associated with transforming the octopus subvolumes from the BGS coordinate system to the FDM coordinate system.

TABLE 5
Rotation angles associated with transformation of octopus subvolumes
from BGS coordinate system to FDM coordinate system

| | Comp1 | Comp2 | Comp3 |
|---|---|---|---|
| dA | 0 | 17.5598 | −12.9899 |
| dC | 0 | −60.9198 | −61.3121 |
| dZ | 75.4657 | 46.5080 | |

### RECITATION OF EMBODIMENTS

Embodiment 1. A computer-implemented method comprising:
receiving a model corresponding to a part to be manufactured by an additive manufacturing process;
receiving a plurality of volume threshold ratio (VTR) values; and
generating a subvolume group corresponding to the model and a clipping plane group corresponding to the model based on each VTR value of the plurality of VTR values, thereby generating a plurality of subvolume groups and a plurality of clipping plane groups.

Embodiment 2. The computer-implemented method of Embodiment 1, further comprising displaying at least one of the plurality of subvolume groups and the plurality of clipping plane groups to a user of an additive manufacturing system.

Embodiment 3. The computer-implemented method of Embodiment 1 or 2, wherein generating the subvolume group corresponding to the model and the clipping plane group corresponding to the model based on each VTR value of the plurality of VTR values comprises applying a beam guided search (BGS) procedure to generate the subvolume group corresponding to the model and the clipping plane group corresponding to the model based on each VTR value of the plurality of VTR values.

Embodiment 4. The computer-implemented method of Embodiment 2 or 3, wherein the additive manufacturing system comprises a tiltable stage which holds the part to be manufactured.

Embodiment 5. The computer-implemented method of any one of Embodiments 2-4, wherein the additive manufacturing system comprises a multi-axis 3D printing system.

Embodiment 6. The computer-implemented method of Embodiment 5, wherein the multi-axis 3D printing system comprises a five-axis 3D printing system.

Embodiment 7. The computer-implemented method of any one of Embodiments 2-6, further comprising selecting a selected subvolume group of the plurality of subvolume groups and a selected clipping plane group of the plurality of clipping plane groups for use in the additive manufacturing process.

Embodiment 8. The computer-implemented method of any one of Embodiments 2-7, further comprising receiving, from the user, a command to select a selected subvolume group of the plurality of subvolume groups and a selected clipping plane group of the plurality of clipping plane groups for use in the additive manufacturing process.

Embodiment 9. The computer-implemented method of Embodiment 7 or 8, further comprising transforming the selected subvolume group and the selected clipping plane group to a transformed subvolume group and a transformed clipping plane group based on a coordinate transformation from a first coordinate system associated with the BGS procedure to a second coordinate system associated with the additive manufacturing system.

Embodiment 10. The computer-implemented method of Embodiment 9, wherein the coordinate transformation comprises a Horn quatemion algorithm (HQA) coordinate transformation.

Embodiment 11. The computer-implemented method of Embodiment 9 or 10, further comprising performing the additive manufacturing process to thereby manufacture the part.

Embodiment 12. The computer-implemented method of any one of Embodiments 1-11, wherein the additive manufacturing process comprises a three-dimensional (3D) printing process.

Embodiment 13. The computer-implemented method of Embodiment 12, wherein the 3D printing process is selected from the group consisting of: fused deposition modeling (FDM), laser metal deposition (LDM), direct metal deposition (DMD), and cold spray metal deposition (CSMD).

Embodiment 14. A computer-implemented method comprising:
receiving a selected subvolume group and a selected clipping plane group associated with a model, the model corresponding to a part to be manufactured by an additive manufacturing process; and
transforming the selected subvolume group and the selected clipping plane group to a transformed subvolume group and a transformed clipping plane group based on a coordinate transformation from a first coordinate system to a second coordinate system associated with an additive manufacturing system.

Embodiment 15. The computer-implemented method of Embodiment 14, wherein the coordinate transformation comprises a HQA coordinate transformation.

Embodiment 16. The computer-implemented method of Embodiment 14 or 15, wherein the selected subvolume group and the selected clipping plane group are generated using a BGS procedure.

Embodiment 17. The computer-implemented method of Embodiment 16, wherein the first coordinate system is associated with the BGS procedure.

Embodiment 18. The computer-implemented method of any one of Embodiments 14-17, further comprising performing the additive manufacturing process to thereby manufacture the part.

Embodiment 19. The computer-implemented method of any one of Embodiments 14-18, wherein the additive manufacturing process comprises a 3D printing process.

Embodiment 20. The computer-implemented method of Embodiment 19, wherein the 3D printing process is selected from the group consisting of: FDM, LDM, DMD, and CSMD.

Embodiment 21. The computer-implemented method of any one of Embodiments 14-20, wherein the additive manufacturing system comprises a tiltable stage which holds the part to be manufactured.

Embodiment 22. The computer-implemented method of any one of Embodiments 14-21, wherein the additive manufacturing system comprises a multi-axis 3D printing system.

Embodiment 23. The computer-implemented method of Embodiment 22, wherein the multi-axis 3D printing system comprises a five-axis 3D printing system.

Embodiment 24. A non-transitory, machine-readable medium having stored thereon machine-readable instructions executable to cause a system to perform operations comprising:
receiving a model corresponding to a part to be manufactured by an additive manufacturing process;
receiving a plurality of VTR values; and
generating a subvolume group corresponding to the model and a clipping plane group corresponding to the model based on each VTR value of the plurality of VTR values, thereby generating a plurality of subvolume groups and a plurality of clipping plane groups.

Embodiment 25. The non-transitory, machine-readable medium of Embodiment 24, wherein the operations further comprise displaying at least one of the plurality of subvolume groups and the plurality of clipping plane groups to a user of an additive manufacturing system.

Embodiment 26. The non-transitory, machine-readable medium of Embodiment 24 or 25, wherein generating the subvolume group corresponding to the model and the clipping plane group corresponding to the model based on each VTR value of the plurality of VTR values comprises applying a BGS procedure to generate the subvolume group corresponding to the model and the clipping plane group corresponding to the model based on each VTR value of the plurality of VTR values.

Embodiment 27. The non-transitory, machine-readable medium of Embodiment 25 or 26, wherein the additive manufacturing system comprises a tiltable stage which holds the part to be manufactured.

Embodiment 28. The non-transitory, machine-readable medium of any one of Embodiments 25-27, wherein the additive manufacturing system comprises a multi-axis 3D printing system.

Embodiment 29. The non-transitory, machine-readable medium of Embodiment 28, wherein the multi-axis 3D printing system comprises a five-axis 3D printing system.

Embodiment 30. The non-transitory, machine-readable medium of any one of Embodiments 24-29, wherein the operations further comprise selecting a selected subvolume group of the plurality of subvolume groups and a selected clipping plane group of the plurality of clipping plane groups for use in the additive manufacturing process.

Embodiment 31. The non-transitory, machine-readable medium of any one of Embodiments 24-30, wherein the operations further comprise receiving, from the user, a command to select a selected subvolume group of the plurality of subvolume groups and a selected clipping plane group of the plurality of clipping plane groups for use in the additive manufacturing process.

Embodiment 32. The non-transitory, machine-readable medium of Embodiment 30 or 31, wherein the operations further comprise transforming the selected subvolume group and the selected clipping plane group to a transformed subvolume group and a transformed clipping plane group based on a coordinate transformation from a first coordinate system associated with the BGS procedure to a second coordinate system associated with the additive manufacturing system.

Embodiment 33. The non-transitory, machine-readable medium of Embodiment 32, wherein the coordinate transformation comprises a HQA coordinate transformation.

Embodiment 34. The non-transitory, machine-readable medium of Embodiment 32 or 33, wherein the operations further comprise performing the additive manufacturing process to thereby manufacture the part.

Embodiment 35. The non-transitory, machine-readable medium of any one of Embodiments 24-34, wherein the additive manufacturing process comprises a 3D printing process.

Embodiment 36. The non-transitory, machine-readable medium of Embodiment 35, wherein the 3D printing process is selected from the group consisting of: FDM, LDM, DMD, and CSMD.

Embodiment 37. A non-transitory, machine-readable medium having stored thereon machine-readable instructions executable to cause a system to perform operations comprising:
receiving a selected subvolume group and a selected clipping plane group associated with a model, the model corresponding to a part to be manufactured by an additive manufacturing process; and
transforming the selected subvolume group and the selected clipping plane group to a transformed subvolume group and a transformed clipping plane group based on a coordinate transformation from a first coordinate system to a second coordinate system associated with an additive manufacturing system.

Embodiment 38. The non-transitory, machine-readable medium of Embodiment 37, wherein the coordinate transformation comprises a HQA coordinate transformation.

Embodiment 39. The non-transitory, machine-readable medium of Embodiment 37 or 38, wherein the selected subvolume group and the selected clipping plane group are generated using a BGS procedure.

Embodiment 40. The non-transitory, machine-readable medium of Embodiment 39, wherein the first coordinate system is associated with the BGS procedure.

Embodiment 41. The non-transitory, machine-readable medium of any one of Embodiments 37-40, wherein the operations further comprise performing the additive manufacturing process to thereby manufacture the part.

Embodiment 42. The non-transitory, machine-readable medium of any one of Embodiments 37-41, wherein the additive manufacturing process comprises a 3D printing process.

Embodiment 43. The non-transitory, machine-readable medium of Embodiment 42, wherein the 3D printing process is selected from the group consisting of: FDM, LDM, DMD, and CSMD.

Embodiment 44. The non-transitory, machine-readable medium of any one of Embodiments 37-43, wherein the additive manufacturing system comprises a tiltable stage which holds the part to be manufactured.

Embodiment 45. The non-transitory, machine-readable medium of any one of Embodiments 37-44, wherein the additive manufacturing system comprises a multi-axis 3D printing system.

Embodiment 46. The non-transitory, machine-readable medium of Embodiment 45, wherein the multi-axis 3D printing system comprises a five-axis 3D printing system.

Embodiment 47. A computer-implemented method comprising:
receiving a model corresponding to a part to be manufactured by an additive manufacturing process;
receiving a plurality of threshold values determined based on a volume of a subvolume of the part; and
generating a subvolume group corresponding to the model and a clipping plane group corresponding to the model based on each threshold value of the plurality of threshold values, thereby generating a plurality of subvolume groups and a plurality of clipping plane groups.

Embodiment 48. A non-transitory, machine-readable medium having stored thereon machine-readable instructions executable to cause a system to perform operations comprising:
receiving a model corresponding to a part to be manufactured by an additive manufacturing process;
receiving a plurality of threshold values determined based on a volume of a subvolume of the part; and
generating a subvolume group corresponding to the model and a clipping plane group corresponding to the model based on each threshold value of the plurality of threshold values, thereby generating a plurality of subvolume groups and a plurality of clipping plane groups.

1. A computer-implemented method comprising:
receiving a model corresponding to a part to be manufactured by an additive manufacturing process;
receiving a plurality of volume threshold ratio (VTR) values; and
generating a subvolume group corresponding to the model and a clipping plane group corresponding to the model based on each VTR value of the plurality of VTR values, thereby generating a plurality of subvolume groups and a plurality of clipping plane groups.

2. The computer-implemented method of claim 1, further comprising displaying at least one of the plurality of subvolume groups and the plurality of clipping plane groups to a user of an additive manufacturing system.

3. The computer-implemented method of claim 1, wherein generating the subvolume group corresponding to the model and the clipping plane group corresponding to the model based on each VTR value of the plurality of VTR values comprises applying a beam guided search (BGS) procedure to generate the subvolume group corresponding to the model and the clipping plane group corresponding to the model based on each VTR value of the plurality of VTR values.

4. The computer-implemented method of claim 2, wherein the additive manufacturing system comprises a tiltable stage which holds the part to be manufactured.

5. The computer-implemented method of claim 2, wherein the additive manufacturing system comprises a multi-axis 3D printing system.

6. The computer-implemented method of claim 5, wherein the multi-axis 3D printing system comprises a five-axis 3D printing system.

7. The computer-implemented method of claim 2, further comprising selecting a selected subvolume group of the plurality of subvolume groups and a selected clipping plane group of the plurality of clipping plane groups for use in the additive manufacturing process.

8. The computer-implemented method of claim 2, further comprising receiving, from the user, a command to select a selected subvolume group of the plurality of subvolume groups and a selected clipping plane group of the plurality of clipping plane groups for use in the additive manufacturing process.

9. The computer-implemented method of claim 7, further comprising transforming the selected subvolume group and the selected clipping plane group to a transformed subvolume group and a transformed clipping plane group based on a coordinate transformation from a first coordinate system associated with the BGS procedure to a second coordinate system associated with the additive manufacturing system.

10. The computer-implemented method of claim 9, wherein the coordinate transformation comprises a Horn quaternion algorithm (HQA) coordinate transformation.

11. The computer-implemented method of claim 9, further comprising performing the additive manufacturing process to thereby manufacture the part.

12. The computer-implemented method of claim 1, wherein the additive manufacturing process comprises a three-dimensional (3D) printing process.

13. The computer-implemented method of claim 12, wherein the 3D printing process is selected from the group consisting of: fused deposition modeling (FDM), laser metal deposition (LDM), direct metal deposition (DMD), and cold spray metal deposition (CSMD).

14. A computer-implemented method comprising:
receiving a selected subvolume group and a selected clipping plane group associated with a model, the model corresponding to a part to be manufactured by an additive manufacturing process; and
transforming the selected subvolume group and the selected clipping plane group to a transformed subvolume group and a transformed clipping plane group based on a coordinate transformation from a first coordinate system to a second coordinate system associated with an additive manufacturing system.

15. The computer-implemented method of claim 14, wherein the coordinate transformation comprises a HQA coordinate transformation.

16. The computer-implemented method of claim 14, wherein the selected subvolume group and the selected clipping plane group are generated using a BGS procedure.

17. The computer-implemented method of claim 16, wherein the first coordinate system is associated with the BGS procedure.

18. The computer-implemented method of claim 14, further comprising performing the additive manufacturing process to thereby manufacture the part.

19. The computer-implemented method of claim 14, wherein the additive manufacturing process comprises a 3D printing process.

20. The computer-implemented method of claim 19, wherein the 3D printing process is selected from the group consisting of: FDM, LDM, DMD, and CSMD.

21. The computer-implemented method of claim 14, wherein the additive manufacturing system comprises a tiltable stage which holds the part to be manufactured.

22. The computer-implemented method of claim 14, wherein the additive manufacturing system comprises a multi-axis 3D printing system.

23. The computer-implemented method of claim 22, wherein the multi-axis 3D printing system comprises a five-axis 3D printing system.

24. A non-transitory, machine-readable medium having stored thereon machine-readable instructions executable to cause a system to perform operations comprising:
receiving a model corresponding to a part to be manufactured by an additive manufacturing process;
receiving a plurality of VTR values; and
generating a subvolume group corresponding to the model and a clipping plane group corresponding to the model based on each VTR value of the plurality of VTR values, thereby generating a plurality of subvolume groups and a plurality of clipping plane groups.

25. A non-transitory, machine-readable medium having stored thereon machine-readable instructions executable to cause a system to perform operations comprising:
receiving a selected subvolume group and a selected clipping plane group associated with a model, the model corresponding to a part to be manufactured by an additive manufacturing process; and
transforming the selected subvolume group and the selected clipping plane group to a transformed subvolume group and a transformed clipping plane group based on a coordinate transformation from a first coordinate system to a second coordinate system associated with an additive manufacturing system.

26. A computer-implemented method comprising:
receiving a model corresponding to a part to be manufactured by an additive manufacturing process;
receiving a plurality of threshold values determined based on a volume of a subvolume of the part; and
generating a subvolume group corresponding to the model and a clipping plane group corresponding to the model based on each threshold value of the plurality of threshold values, thereby generating a plurality of subvolume groups and a plurality of clipping plane groups.

27. A non-transitory, machine-readable medium having stored thereon machine-readable instructions executable to cause a system to perform operations comprising:
receiving a model corresponding to a part to be manufactured by an additive manufacturing process;
receiving a plurality of threshold values determined based on a volume of a subvolume of the part; and
generating a subvolume group corresponding to the model and a clipping plane group corresponding to the model based on each threshold value of the plurality of threshold values, thereby generating a plurality of subvolume groups and a plurality of clipping plane groups.
